(19) United States
(12) Patent Application Publication
(10) Pub. No.: US 2007/0179296 A1
(43) Pub. Date: Aug. 2, 2007

(54) PROCESS FOR MANUFACTURING PICOLINATE BORINIC ESTERS

(75) Inventors: Kirk R. Maples, San Jose, CA (US); Stephen J. Baker, Mountain View, CA (US); Glenn L. Stahl, Buffalo Grove, IL (US); Michael DiPierro, Wadsworth, IL (US); Christopher J. Tokar, Plainfield, IL (US); Premchandran H. Ramiya, Cupertino, CA (US); Siead I. Zegar, Orland Park, IL (US)

Correspondence Address: MORGAN, LEWIS & BOCKIUS LLP (SF), 2 PALO ALTO SQUARE, 3000 El Camino Real, Suite 700, PALO ALTO, CA, 94306, US

(73) Assignee: Anacor Pharmaceuticals, Inc., Palo Alto, CA (US)

(21) Appl. No.: 11/616,774

(22) Filed: Dec. 27, 2006

Related U.S. Application Data
(60) Provisional application No. 60/754,750, filed on Dec. 28, 2005.

(51) Int. Cl. C07F 5/02

(52) U.S. Cl. 546/13

(57) ABSTRACT

The present invention relates to the field of boron-containing compounds, particularly boron compounds and pharmaceutical compositions thereof that exhibit with antibacterial and/or anti-inflammatory activities, and uses thereof. Methods for preparing and using these boron compounds and pharmaceutical compositions thereof, are also provided.

### FIELD OF THE INVENTION

The present invention relates to boron-containing compounds, particularly boron compounds and pharmaceutical compositions thereof that exhibit antibacterial and/or anti-inflammatory activities. Methods for preparing and using these boron compounds are also provided.

### BACKGROUND OF THE INVENTION

Acne vulgaris is the most common skin disease which affects 85% of individuals at some time between the ages of 12- and 24 years. At present, 45 million people in the U.S. have acne, while 17 million Americans seek treatment every year. Acne is a disease of the pilosebaceous unit, involving abnormalities in sebum production, follicular epithelial desquamation, bacterial proliferation and inflammation. The pathogenesis of acne is multifactorial, with microbial proliferation and inflammation acting as central mediators to this condition. In hair follicles, the mixture of cells and sebum creates an environment for the proliferation of Propionibacterium acnes (P. acnes), a bacterium that occurs commonly on the skin. Chemotactic factors released by P. acnes attract lymphocytes and neutrophils, as well as producing other pro-inflammatory molecules. This results in an inflammatory process where a plug composed of skin cells and sebum in sebaceous follicles is formed.

Current treatments for acne include antibiotics, applied topically and systemically, and topically applied retinoids (e.g., retinoic acid). But these treatments are not fully satisfactory due to the long term course of therapy: usually treatment can take four to six weeks or longer. In addition, topical irritation and systemic side effects are also major problems with current products. Therefore, there is a need for an improved therapy for acne that is shorter acting, devoid of side effects, and inhibits both the bacterial and inflammatory contributors to the pathogenesis.

A new therapy currently in human clinical trials comprises treating acne with the active pharmaceutical ingredient 2-( {[bis(3-chloro-4-methylphenyl)boryl]oxy}carbonyl)pyridin-3-ol (1) (“API”) in a topical 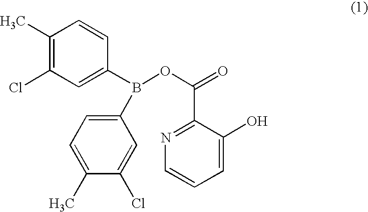
formulation. This compound has shown promising antibacterial, anti-inflammatory, and other useful therapeutic properties as discussed, for example, in co-pending U.S. patent applications Ser. Nos. 10/740,304; 10/867,465; 60/579,421; 60/579,476; and 60/579,419, each of which is incorporated herein by reference in its entirety and for all purposes; and in PCT publication WO 04/056322, which also is incorporated herein by reference in its entirety and for all purposes.

Reliable synthetic methodologies exist for preparing API in single-gram-scale quantities sufficient for laboratory and pre-clinical studies. However, human clinical trials typically require tens or even hundreds of grams of a compound for testing. At such scales, new methods are needed to make API at a reasonable cost and with reasonable safety factors. The present invention addresses these problems by providing methods for preparing borinic esters, including API, that meet these demands.

### SUMMARY OF THE INVENTION

One aspect of the invention relates to a method for manufacturing a compound of Formula I 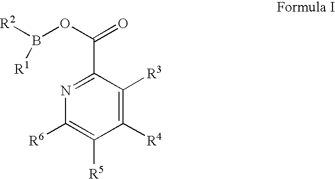
and its pharmaceutically acceptable salts, hydrates, and solvates, comprising reacting nucleophilic equivalents of R¹ and R² with a trialkylborate to form an alkyl borinic acid ester; treating the borinic acid ester with an absorbent; and combining the treated borinic acid ester with a picolinic acid under conditions effective to form the compound, wherein: R¹ and R² are selected independently from the group consisting of alkyl, heteroalkyl, aryl, and heteroaryl; R³-R⁶ are independently selected from the group consisting of hydrogen, hydoxy, amino, carboxy, cyano, halo, nitro, sulfo, thio, carbamoyl, substituted or unsubstituted alkyl, substituted or unsubstituted aryl, and substituted or unsubstituted heteroaryl; or R⁵ and R⁶ together with the ring to which they are attached form a substituted or unsubstituted aryl or substituted or unsubstituted heteroaryl ring.

An embodiment of invention relates to a method for producing 2-({[bis(3-chloro-4-methylphenyl)boryl]oxy}carbonyl)pyridin-3-ol (1), and its pharmaceutically acceptable salts, hydrates, and solvates, comprising reacting 3-chloro-4-methylphenyl magnesium bromide with trimethylborate under conditions effective to form methyl bis(3-chloro-4-methylphenyl)borinate; treating the methyl bis(3-chloro-4-methylphenyl)borinate with an absorbent; and reacting the methyl bis(3-chloro-4-methylphenyl)borinate with 3-hydroxypicolinic acid under conditions effective to form 2-({[bis(3-chloro-4-methylphenyl)boryl]oxy}carbonyl)pyridin-3-ol.

Another embodiment of the invention relates to a method for producing 2-({[bis(3-chloro-4-methylphenyl)boryl]oxy}carbonyl)pyridin-3-ol, and its pharmaceutically acceptable salts, hydrates, and solvates, comprising reacting 3-chloro-4-methylphenyl magnesium bromide with trimethylborate under conditions effective to form methyl bis(3-chloro-4-methylphenyl)borinate; treating the methyl bis(3-chloro-4-methylphenyl)borinate with ethanol and a first absorbent to form a mixture which is heated; treating 3-hydroxypicolinic acid with a second absorbent; filtering the mixture of the second absorbent and the 3-hydroxypicolinic acid and the mixture of the first absorbent and the methyl bis(3-chloro-4-methylphenyl)borinate; and reacting the filtered bis(3-chloro-4-methylphenyl)borinate with the filtered 3-hydroxypicolinic acid under conditions effective to form 2-( {[bis(3-chloro-4-methylphenyl)boryl]oxy}carbonyl)pyridin-3-ol.

Another aspect of the invention relates to the compound 2-({[bis(3-chloro-4-methylphenyl)boryl]oxy)carbonyl)pyridin-3-ol in substantially anhydrous crystalline form.

Another aspect of the invention relates to a pharmaceutical composition comprising a pharmaceutically effective amount of 2-({[bis(3-chloro-4-methylphenyl)boryl]oxy)carbonyl)pyridin-3-ol in substantially anhydrous crystalline form.

These and other aspects and advantages will become apparent when the Description below is read in conjunction with the accompanying Drawings.

### BRIEF DESCRIPTION OF THE DRAWINGS

FIG. 1A, FIG. 1B, and FIG. 1C each provide a partial schematic overview of an exemplary process for preparing API in accordance with one embodiment of the present invention. Taken together, FIGS. 1A through 1C describe a complete embodiment of an exemplary process for preparing API in accordance with the present invention.

### DETAILED DESCRIPTION OF THE INVENTION

In one aspect, the present invention provides new methods for preparing compounds having the general structure of Formula I and its pharmaceutically acceptable salts, hydrates, and solvates.

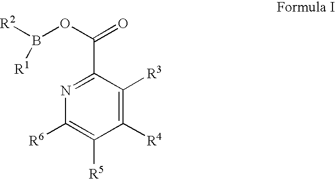

Definitions

As defined herein, the term “alkyl,” by itself or as part of another substituent, means, unless otherwise stated, a straight or branched chain, or cyclic hydrocarbon radical, or combination thereof, which may be fully saturated, mono- or poly-unsaturated and can include di- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclopentyl, cyclohexyl, (cyclohexyl)methyl, cyclopropylmethyl, and homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl” is also intended to include, for example, alkylcarbonyl, alkylcarboxyl, alkylcarbamoyl, dialkylcarbamoyl and alkylcarbonyldioxy, and encompasses both substituted and unsubstituted alkyl groups.

As defined herein, the term “heteroalkyl,” by itself or in combination with another term, means, unless otherwise stated, a stable straight or branched chain, or cyclic hydrocarbon radical, or combinations thereof, consisting of the stated number of carbon atoms and at least one heteroatom selected from the group consisting of O, N, Si and S, and wherein the nitrogen and sulfur atoms may optionally be oxidized and the nitrogen heteroatom may optionally be quaternized. The heteroatom(s) O, N and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, and —CH═CH—N(CH₃)—CH₃. Up to two heteroatoms may be consecutive, such as, for example,

—CH₂—NH—OCH₃ and —CH₂—O—Si(CH₃)₃. “Heteroalkyl” also encompasses “heteroalkylene” which by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. Heteroatoms can also occupy either or both of the chain termini (e.g., alkyleneoxy, alkylenedioxy, alkyleneamino, alkylenediamino, alkylamino, dialkylamino, thioalkyl, alkylsulfonyl, alkylsulfamoyl, dialkylsulfamoyl, alkylsulfinamoyl, dialkylsulfinamoyl and the like). “Heteroalkyl” is also intended to include heterocycloalkyl, which includes, for example, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like. “Heteroalkyl” encompasses both substituted and unsubstituted heteroalkyl groups.

As defined herein, the terms “halo” or “halogen,” by themselves or as part of another substituent, mean, unless otherwise stated, a fluorine, chlorine, bromine, or iodine atom. Additionally, terms such as “haloalkyl,” are meant to include monohaloalkyl and polyhaloalkyl. For example, the term “halo(C₁-C₄)alkyl” is mean to include, but not be limited to, trifluoromethyl, 2,2,2-trifluoroethyl, 4-chlorobutyl, 3-bromopropyl, and the like.

As defined herein, the term “aryl” is intended to mean, unless otherwise stated, a polyunsaturated, aromatic substituent that can be a single ring or multiple rings (preferably from 2 to 3 rings), which are fused together or linked covalently. Non-limiting examples of aryl include phenyl, 1-naphthyl, 2-naphthyl and 4-biphenyl. Exemplary classes of compounds encompassed by the term “aryl” include aralkyl, aryloxy, arylamino, diarylamino, aralkyloxy, aralkylthio, aralkylamino, diaralkylamino, alkylarylamino, arylcarbonyl, arylcarbamoyl, aralkylcarbonyl, aralkylcarbamoyl, diarylcarbamoyl, diaralkylcarbamoyl, alkylarylcarbamoyl, arylsulfonyl, aralkylsulfonyl, arylsulfinyl, aralkylsulfinyl, arylcarbonyldioxy, aralkylcarbonyldioxy, arylsulfamoyl, aralkylsulfamoyl, diarylsulfamoyl, diaralkylsulfamoyl, alkylarylsulfamoyl, arylsulfinamoyl, aralkylsulfinamoyl, diarylsulfinamoyl, diaralkylsulfinamoyl and alkylarylsulfinamoyl. “Aryl” encompasses both substituted and unsubstituted aryl groups.

The term “heteroaryl” refers to aryl groups (or rings) in which the ring carbon atoms are replaced by from one to four heteroatoms selected from N, O, and S, wherein the nitrogen and sulfur atoms are optionally oxidized, and the nitrogen atom(s) are optionally quatemized. A heteroaryl group can be attached to the remainder of the molecule through a heteroatom. Non-limiting examples of heteroaryl groups include 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Exemplary classes of compounds that are encompassed by the term “heteroaryl” include heteroaralkyl, heteroaryloxy, heteroaralkyloxy, heteroarylthio, heteroaralkylthio, heteroarylamino, heteroaralkylamino, diheteroarylamino, diheteroaralkylamino, heteroarylcarbonyl, heteroaralkylcarbonyl, heteroarylcarbamoyl, heteroaralkylcarbamoyl, diheteroarylcarbamoyl, diheteroaralkylcarbamoyl, heteroarylsulfonyl, heteroaralkylsulfonyl, heteroarylsulfinyl, heteroaralkylsulfinyl, heteroaralkylcarbonyldioxy, heteroarylsulfamoyl, heteroaralkylsulfamoyl, diheteroarylsulfamoyl, diheteroaralkylsulfamoyl, heteroarylsulfinamoyl, heteroaralkylsulfinamoyl, diheteroarylsulfinamoyl and diheteroaralkylsulfinamoyl. “Heteroaryl” encompasses both substituted and unsubstituted heteroaryl groups.

As defined herein, “a picolinic acid” is intended to include both picolinic acid and substituted picolinic acids.

As defined herein, a “non-solvent” is a liquid in which a compound or compounds of interest is not substantially soluble.

As defined herein, “adsorption” refers to an interaction with the surface of a material, while “absorption” refers to incorporation into a material through its pores (interstices). A material may provide possess both adsorbent and absorbent properties.

Exemplary substituents for the alkyl and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) are generically referred to as “alkyl group substituents,” and they can be one or more of a variety of groups selected from, but not limited to: —OR′, ═O, ═NR′,

═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R″′)═NR″″, —NR—C(NR′R″)═NR′″, —S(O)R′, —S(O)₂R′, —S(O)₂NR′R″, —NRSO₂R′, —CN and —NO₂ in a number ranging from zero to (2m′+1), where m′ is the total number of carbon atoms in such radical. R′, R″, R′″ and R″″ each preferably independently refer to hydrogen, substituted or unsubstituted heteroalkyl, substituted or unsubstituted aryl, e.g., aryl substituted with 1-3 halogens, substituted or unsubstituted alkyl, alkoxy or thioalkoxy groups, or arylalkyl groups. When a compound of the invention includes more than one R group, for example, each of the R groups is independently selected as are each R′, R″, R′″ and R″″ groups when more than one of these groups is present. When R′ and R″ are attached to the same nitrogen atom, they can be combined with the nitrogen atom to form a 5-, 6-, or 7-membered ring. For example, —NR′R″ is meant to include, but not be limited to, 1-pyrrolidinyl and 4-morpholinyl. From the above discussion of substituents, one of skill in the art will understand that the term “alkyl” is meant to include groups including carbon atoms bound to groups other than hydrogen groups, such as haloalkyl (e.g., —CF₃ and —CH₂CF₃) and acyl (e.g., —C(O)CH₃, —C(O)CF₃, —C(O)CH₂OCH₃, and the like).

Exemplary substituents for the aryl and heteroaryl groups are generically referred to as “aryl group substituents.” The substituents are selected from, for example: halogen, —OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR″″, —NR—C(NR′R″)═NR′″, —S(O)R′, —S(O)₂R′, —S(O)₂NR′R″, —NRSO₂R′, —CN and —NO₂, —R′, —N₃, —CH(Ph)₂, fluoro(C₁-C₄)alkoxy, and fluoro(C₁-C₄)alkyl, in a number ranging from zero to the total number of open valences on the aromatic ring system; and where R′, R″, R′″ and R″″ are preferably independently selected from hydrogen, substituted or unsubstituted alkyl, substituted or unsubstituted heteroalkyl, substituted or unsubstituted aryl and substituted or unsubstituted heteroaryl. When a compound of the invention includes more than one R group, for example, each of the R groups is independently selected as are each R′, R″, R′″ and R″″ groups when more than one of these groups is present.

As defined herein, the term “heteroatom” is meant to include oxygen (O), nitrogen (N), sulfur (S) and silicon (Si).

Compounds

R¹ and R² are independently selected from the group consisting of substituted or unsubstituted alkyl, substituted or unsubstituted aryl, aralkyl, and heteroaryl.

R³-R⁶ are independently selected from the group consisting of: hydrogen, hydroxy, amino, carboxy, cyano, halo, nitro, sulfo, thio, carbamoyl, substituted or unsubstituted alkyl, substituted or unsubstituted aryl and substituted or unsubstituted heteroaryl. R³-R⁶ may thus include, for example, aralkyl, heteroaralkyl, cycloalkyl, heterocyclyl, alkoxy, aryloxy, aralkyloxy, heteroaryloxy, heteroaralkyloxy, alkylthio, arylthio, aralkylthio, heteroarylthio, heteroaralkylthio, alkylamino, arylamino, aralkylamino, heteroarylamino, heteroaralkylamino, dialkylamino, diaralkylamino, diheteroarylamino, diheteroaralkylamino, alkylarylamino, alkylcarbonyl, arylcarbonyl, aralkylcarbonyl, heteroarylcarbonyl, heteroaralkylcarbonyl, alkylcarbamoyl, arylcarbamoyl, aralkylcarbamoyl, heteroarylcarbamoyl, heteroaralkylcarbamoyl, dialkylcarbamoyl, diarylcarbamoyl, diaralkylcarbamoyl, diheteroarylcarbamoyl, diheteroaralkylcarbamoyl, alkylarylcarbamoyl, alkylsulfonyl, arylsulfonyl, aralkylsulfonyl, heteroarylsulfonyl, heteroaralkylsulfonyl, alkylsulfinyl, arylsulfinyl, aralkylsulfinyl, heteroarylsulfinyl, heteroaralkylsulfinyl, alkylcarbonyldioxy, arylcarbonyldioxy, aralkylcarbonyldioxy, heteroarylcarbonyldioxy, heteroaralkylcarbonyldioxy, alkylsulfamoyl, arylsulfamoyl , aralkylsulfamoyl, heteroarylsulfamoyl, heteroaralkylsulfamoyl, dialkylsulfamoyl, diarylsulfamoyl, diaralkylsulfamoyl, diheteroarylsulfamoyl, diheteroaralkylsulfamoyl, alkylarylsulfamoyl; alkylsulfinamoyl, arylsulfinamoyl, aralkylsulfinamoyl, heteroarylsulfinamoyl, heteroaralkylsulfinamoyl, dialkylsulfinamoyl, diarylsulfinamoyl, diaralkylsulfinamoyl, diheteroarylsulfinamoyl, diheteroaralkylsulfinamoyl and alkylarylsulfinamoyl. Further, R⁵ and R⁶ together with the ring to which they are attached may form an aromatic ring.

In one embodiment, the method of the invention comprises reacting nucleophilic equivalents of R¹ and R² with a trialkylborate under conditions effective to form the corresponding alkyl borinic acid ester (i.e., (R¹R²BO(Alkyl)). As used herein, “nucleophilic equivalents of R¹ and R²” refers to synthons of R¹ and R² that can be reacted with a trialkylborate to form a desired borinic alkyl ester in which R¹ and R² are bound to the central boron atom. Any synthon of R¹ and R² that is effective to complete this reaction is suitable for use in the present invention. Examples of suitable synthons include, but are not limited to, the lithium metal and Grignard reagents corresponding to R¹ and R². A particular example of such a Grignard reagent is 3-chloro-4-methylphenyl magnesium bromide. The synthons for R¹ and R² can be prepared using known methods and materials or purchased from commercial sources. Suitable trialkylborates include trimethylborate ((CH₃O)₃B), which can be purchased commercially. The nucleophilic equivalents of R¹ and R² and the trialkylborate can be combined using known conditions and methods to prepare the corresponding borinic acid alkyl ester. This borinic acid alkyl ester is treated with an absorbent, followed by an optionally substituted picolinic acid under conditions sufficient to form the desired compound.

For compounds of Formula I, R¹ is an optionally substituted aryl. In another embodiment of the invention, R¹ is an optionally substituted aryl and R² is an optionally substituted aryl. Other embodiments include those compounds of Formula I where R¹ and R² both are optionally substituted phenyl groups. In yet another embodiment, R¹ and R² both are phenyl groups substituted with alkyl and halo. In a particular embodiment, R¹, and R² both are 3-chloro-4-methylphenyl groups.

When R¹ and R² both are 3-chloro-4-methylphenyl groups, reaction with the trialkylborate will provide an alkyl bis-(3-chloro-4-methylphenyl)borinic ester. When the trialkylborate is specifically trimethylborate, the resulting borinic ester is methyl bis(3-chloro-4-methylphenyl)borinate.

Reaction of a borinic alkyl ester with a picolinic acid provides the desired product having the general structure of Formula I. This step can typically be accomplished by combining the borinic alkyl ester with the picolinic acid in a reaction vessel and heating the mixture. In a more particular embodiment, the method of the invention includes combining the picolinic acid with an absorbent, filtering the absorbent, and reacting the picolinic acid with the borinic ester. In another embodiment, the picolinic acid is 3-hydroxypicolinic acid. In one embodiment, the borinic ester is methyl bis(3-chloro-4-methylphenyl)borinate and the picolinic acid is 3-hydroxypicolinic acid.

A suitable absorbent for use in the present invention is any material with a high surface and porosity that allows for absorption and/or adsorption. Exemplary absorbents include alumina, celite, silica, activated carbon and clays, such as, for example, bentonite clay. In one embodiment, the absorbent is activated carbon.

The final product can be crystallized to provide materials of uniformity and purity sufficient for clinical studies in humans. In general, standard methods and materials can be used to make the crystals. In one embodiment, the crystallization of the crude product of API is performed using a seed crystal of confirmed purity and structure. Such seed crystals can be produced using known laboratory scale procedures as described, e.g., in the above-referenced U.S. patent applications and PCT publication. In some embodiments, the purity of the crystalline API is at least about 97%, or at least about 98%, or at least about 99%. In other embodiments, the purity of the crystalline API is at least about 99.2%, or at least about 99.4%, or at least about 99.6%, or at least about 99.8%.

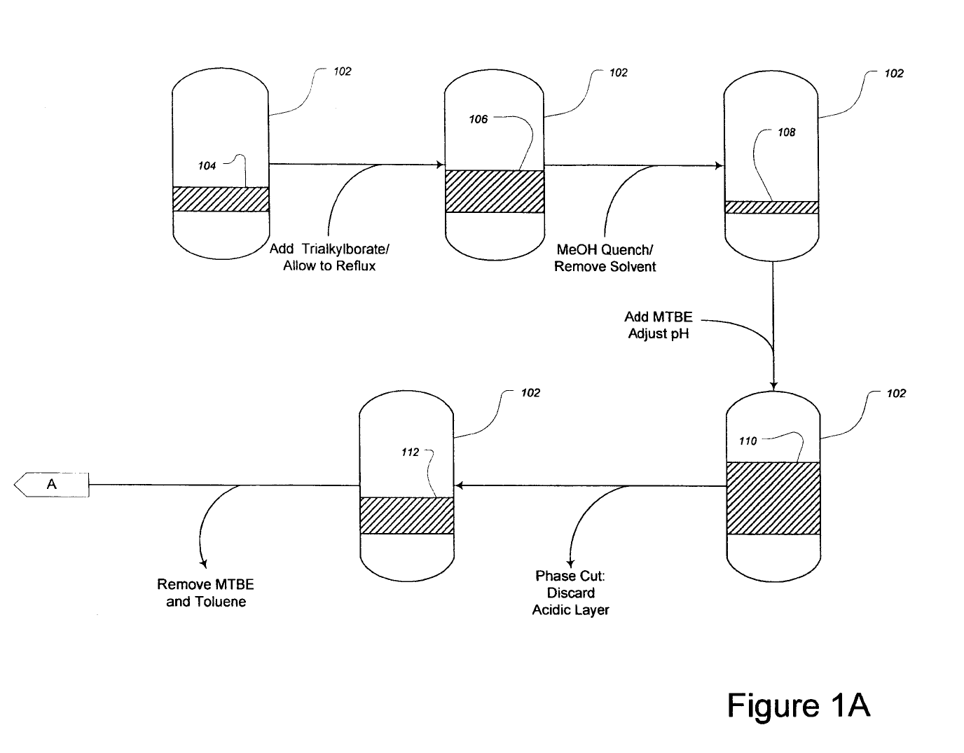

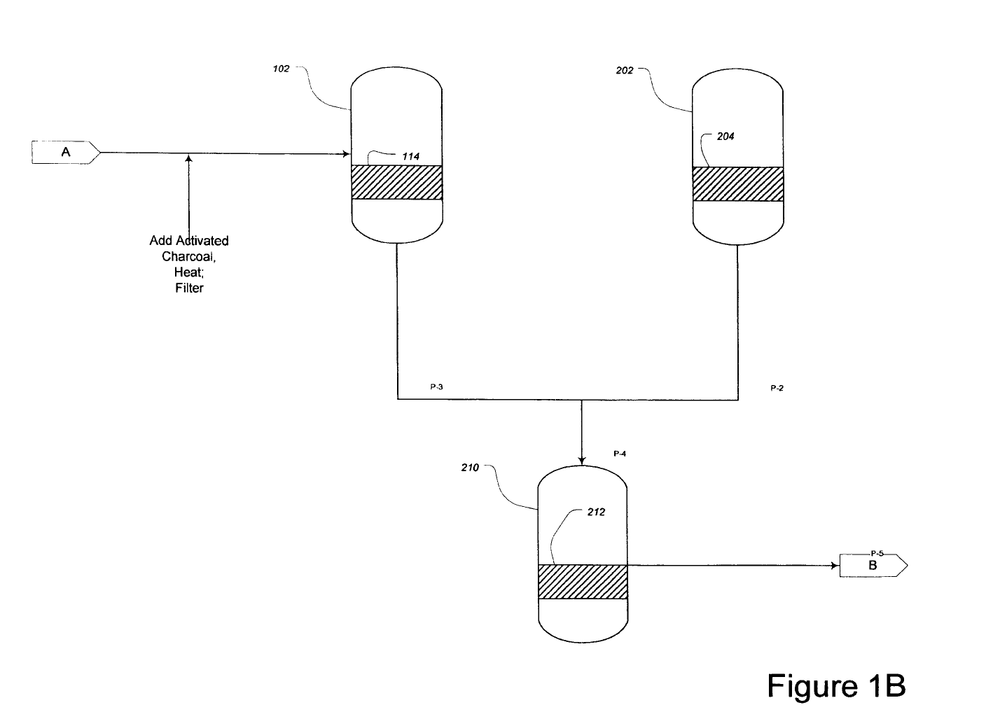

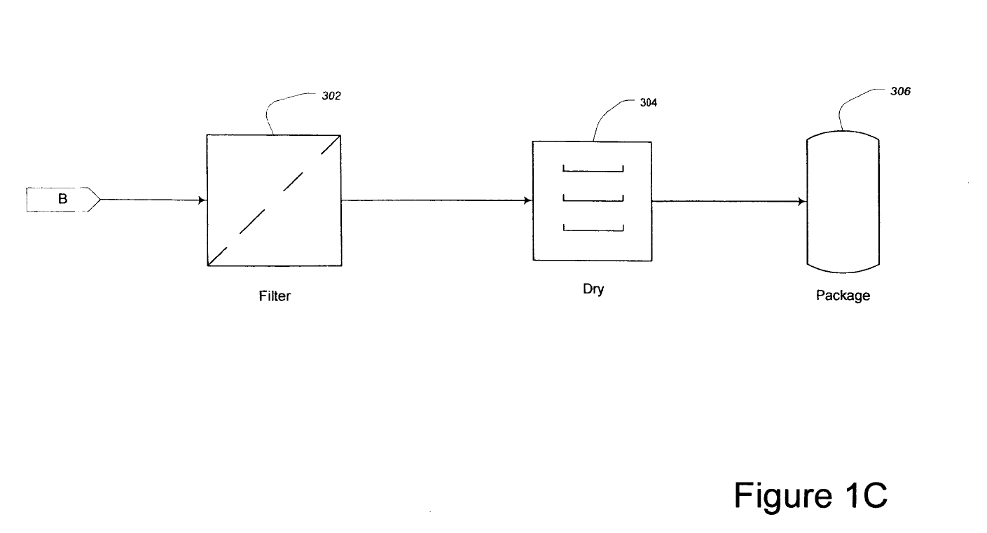

An overview of one embodiment of the invention for preparing API in a quantity and quality suitable for clinical trials will now be described with reference to FIGS. 1A-1C.

Starting with reference to FIG. 1A, magnesium metal (Mg) and tetrahydofuran (THF) were introduced into a reaction vessel (102) along with 4-bromo-2-chlorotoluene to form the corresponding Grignard reagent solution (i.e., 3-chloro-4-methylphenyl magnesium bromide) (104) in THF. Next, trimethylborate was combined with the Grignard solution (104) under reflux to form the methyl bis(3-chloro-4-methylphenyl)borinic acid ester product solution (106). The reaction was then quenched with methanol (MeOH), and the resulting solution concentrated to form a syrup (108). The syrup was next partitioned using methyl tert-butyl ether (MTBE) and 1-Normal (1 N) hydrochloric acid (HCI), and the pH was adjusted to a value of less than one (110). The layers were separated and the acidic aqueous fraction was discarded, leaving the remaining organic layer as a crude solution of the borinic acid (112). The bulk of the solvent was removed, e.g., by evaporation. The residual solvents (THF, MTBE, water, and methanol) were removed by adding toluene and evaporating the resulting solution to produce a syrup of methyl bis(3-chloro-4-methylphenyl)borinic acid (114).

Referring now to FIG. 1B, in a separate vessel (202), the picolinic acid (e.g., 3-hydroxypicolinic acid), was treated with activated carbon in solution (204) (e.g., a solution of ethanol (EtOH) and water), filtered, and transferred to a second vessel (210) where it was combined with the bis(3-chloro-4-methylphenyl)borinic acid (114) prepared from the scheme depicted in FIG. 1A to form the desired product. The product was further purified (e.g., by crystallization) as necessary.

With reference to FIG. 1C, the final product was filtered (302), dried (304), and packaged for storage (306).

The methods described herein produce crystals that were determined to be substantially anhydrous, with a dominant crystal form having a melting point between about 170° C. and about 176° C., more specifically between about 173° C. and about 175° C., still more specifically between about 174° C. and about 175° C., and, in particular, about 174° C. A second form was also noted that had a melting point between about 171° C. and about 173° C., more particularly between about 171° C. and about 172° C., and in particular about 172° C.

The crystalline form of API as prepared using the methods described herein can be stored in a substantially anhydrous environment, such as a suitable sealed container, until ready for use. More particularly, the container may be light-resistant. Examples of suitable containers include, without limitation, ampules, bags (e.g., mylar bags), and bottles.

The crystalline form of API as prepared using the methods described herein can be used in pharmaceutical compositions using methods and materials that are well known to those having ordinary skill in the art, as exemplified in commonly available texts (e.g., Gennaro 2000; Harman, Limbard, et al 2001; Auden 2002). Examples of more specific formulations are described, for example, in co-pending U.S. Provisional Patent Application Ser. No. 60/665,178, which is incorporated herein by reference in its entirety and for all purposes.

The compounds of the present invention may also contain unnatural proportions of atomic isotopes at one or more of the atoms that constitute such compounds. For example, the compounds may be radiolabeled with radioactive isotopes, such as for example tritium (³H), iodine-125 (¹²⁵I) or carbon-14 (¹⁴C). All isotopic variations of the compounds of the present invention, whether radioactive or not, are intended to be encompassed within the scope of the present invention.

### EXAMPLES

The following Examples are provided to illustrate certain aspects of the present invention and to aid those of skill in the art in the art in practicing the invention. These Examples are in no way to be considered to limit the scope of the invention in any manner.

### Example 1

### Preparation of 2-({[Bis(3-chloro-4-methylphenyl)boryl]oxy}carbonyl)pyridin-3-ol (“API”) (1)

Preparation of 3-chloro-4-methylphenyl magnesium bromide
Step 1: Mg metal (3.7 equivalents) and tetrahydrofuran (THF) (36 L/kg of Mg) were added to a suitable reactor at ambient temperature.
Step 2: A solution of 4-bromo-2-chlorotoluene (3.5 equivalents) in tetrahydrofuran (1.9 L THF /kg of 4-bromo-2-chlorotoluene) was added to the mixture from Step 1. The rate of addition was controlled to avoid excessive refluxing due to heat evolution. Grignard reagent formation was complete when the refluxing subsided, at which time a small amount of Mg metal remained in an otherwise pale, clear Grignard reagent solution.

Preparation of Bis(3-chloro-4-methylphenyl)borinic acid

Step 1: The Grignard solution from the previous step was cooled to below 10° C.

Step 2: A solution of trimethylborate (1.0 equivalent) in THF (7.7 L tetrahydrofuran/kg of trimethylborate) was added to the Grignard solution.

Step 3: The resulting mixture was incubated at about 40 to about 50° C. for about 16 to about 20 hours.

Step 4: The mixture was then cooled to below 10° C.

Step 5: 12 equivalents of methanol were added to the mixture.

Step 6: The THF and methanol present in the mixture were evaporated under vacuum.

Step 7: The resulting syrup was partitioned using methyl tert-butyl ether (27 L/kg of trimethylborate) and 1 N HCl (27 L/kg of trimethylborate).

Step 8: The aqueous layer was adjusted to a pH of ≦about 1 using concentrated HCl.

Step 9: The layers were separated and the aqueous layer discarded.

Step 10: The methyl tert-butyl ether was evaporated under vacuum.

Step 11: To remove residual THF, methanol, methyl tert-butyl ether and water, toluene (17 L toluene/kg of trimethylborate) was added to the reaction and subsequently evaporated under vacuum.

Step 12: The resulting syrup was dissolved in ethanol (8 L/kg of theoretical 3-hydroxypyridine-2-carbonyloxybis(3-chloro-4-methylphenyl)borane).

Step 13: Activated carbon (5 wt % based on 3-hydroxypicolinic acid; see below) was added to the ethanol solution and the mixture was refluxed for about 5 to about 10 min, and then filtered to remove the activated carbon.

Preparation of 2-({[Bis(3-chloro-4-methylphenyl)boryl]oxy)carbonyl)pyridin-3-ol (1)

Step 1: 3-hydroxypicolinic acid (1.0 equivalent), water (4 L/kg of theoretical 3-hydroxypyridine-2-carbonyloxybis(3-chloro-4-methylphenyl)borane), and ethanol (4 L/kg of theoretical 3-hydroxypyridine-2-carbonyloxy-bis(3-chloro-4-methylphenyl)-borane) were combined, and the mixture was heated to about 40 to about 50° C. for approximately 15 minutes.

Step 2: Activated carbon (5 wt % based upon 3-hydroxypicolinic acid) was added to the mixture, which was stirred about 15 minutes, then filtered to remove the activated carbon.

Step 3: The 3-hydroxypicolinic acid solution was then transferred to a glass reactor.

Step 4: The bis(3-chloro-4-methylphenyl)borinic acid solution from Step 13 as previously described was added to the mixture.

Step 5: The mixture was heated. At about 35 to about 45° C., a precipitate formed, which then dissolved as the mixture was continued to be heated to reflux (approximately 81° C.). Upon reaching reflux, an effectively clear solution was obtained. The mixture was refluxed for about 15 minutes.

Step 6: The solution was allowed to cool. At approximately about 70 to about 75° C., the solution was seeded with authentic (i.e., previously prepared and confirmed) 2-( {[bis(3-chloro-4-methylphenyl)boryl]oxy}carbonyl)pyridin-3-ol (1). Crystallization occurred as the mixture cooled to 25° C. over a period of about 10 to about 15 hours. The crystalline slurry, which comprised the product, was held at ambient conditions for about 12 to about 15 hours. The product slurry was subsequently filtered and washed with cold (about 5° C.) ethanol/water (3:1 v:v) to provide 1-2 L/kg of I (theoretical) in a wet cake.

Step 7: The wet cake was dried in trays at ambient temperature without applied vacuum to provide a substantially crystalline product

Step 8: The product was blended and packaged in sealed, light resistant containers, for storage at room temperature.

### Example 2

### Properties of Crystalline Forms of 2-{[Bis(3-chloro-4-methylphenyl)boryl]oxy}carbonyl)pyridin-3-ol (API)

The crystals of API provided by the above-described process were evaluated for chemical stability and composition. A polymorph screen was performed to determine the presence of different crystalline species of API. Different crystal forms were prepared by standard crystallization techniques typically used when searching for polymorphs. Exemplary techniques used in the present invention are listed below.

Drown-out: A sample of API was dissolved in a solvent capable of dissolving at least 100 mg of API per mL of solvent. A “non-solvent” was added an amount sufficient to cause precipitation of the API. The solids were isolated by filtration and dried.

Slow Evaporation: A sample of API was dissolved in a solvent and the resulting solution was allowed to evaporate slowly by keeping the solution in a covered vial, where the cover had a pin-hole in it. The vial was then placed in a clean area with a constant draft, normally at ambient temperature. Solids were collected after the solvent had completely evaporated.

Fast Evaporation: A sample of API was dissolved in a solvent and the resulting solution was allowed to evaporate spontaneously by keeping the solution in an open vial with no cover. The vial was then placed in a clean area with a constant draft, normally at ambient temperature. Solids were collected after the solvent had completely evaporated.

Slow Cooling: A sample of API was dissolved in a solvent in a sealed vial at elevated temperatures using a heating block such that no undissolved API was present. The solvent was selected for its ability to dissolve a small amount of API at ambient temperature, usually about 50 mg /mL to about 100 mg /mL. The solution was then allowed to cool slowly, preferably in a controlled way or by letting the heating block cool spontaneously. The resulting solids were collected by filtration and dried.

Fast Cooling: The API was added to a solvent in a sealed vial at elevated temperatures using a heating block. The solvent was selected for its ability to dissolve a small amount of API at ambient temperature, usually about 50 mg /mL to about 100 mg /mL. The hot solution had undissolved solids remaining. The solution was then cooled suddenly by placing the vial in an ice bath. The solids were collected by filtration and dried.

API solids were isolated by using any of the following exemplary conditions or combinations thereof:
1. Slow evaporation from methylethylketone (MEK);
2. Slow evaporation from tetrahydrofuran (THF);
3. Slow evaporation from acetone;
4. Slow evaporation from 1,2-dimethoxyethane (DME);
5. Drown-out from acetone with hexane or heptane;
6. Drown-out from acetone with methyl tert-butylether (MTBE);
7. Drown-out from acetonitrile (ACN) with hexane or heptane;
8. Drown-out from ACN with water;
9. Drown-out from MEK with water;
10. Drown-out from ACN with water (repeat);
11. Drown-out from DME with water;
12. Drown-out from DME with hexanes;
13. Drown-out from THF with water;
14. Drown-out from THE with hexanes;
15. 1 Week equilibration in absolute ethanol (EtOH);
16. 1 Week equilibration in 90% EtOH, 20;
17. Fast evaporation from dichloromethane (CH₂Cl₂);
18. Fast evaporation from THF;
19. Fast evaporation from ACH;
20. Fast evaporation from DME;
21. Fast evaporation from acetone;
22. Fast evaporation from MEK;
23. Fast evaporation from ethyl acetate (EtOAc);
24. Fast cooling from methanol (MeOH);
25. Fast cooling from EtOH;
26. Fast cooling from 2-propanol (2-PrOH);
27. Fast cooling from toluene;
28. Slow cooling from MeOH;
29. Slow cooling from EtOH;
30. Slow cooling from 2-PrOH;
31. Slow cooling from toluene.

All collected solids were characterized by differential scanning calorimetry (DSC) and thermal gravimetric analysis (TGA) for all samples and by powder x-ray diffraction (PXRD) for selected samples.

The most thermodynamically stable crystals of API were those obtained by crystallization from ethanol-water as described herein. The crystals were determined using DSC and TGA to be substantially anhydrous, with a dominant form exhibiting a melting point between about 170° C. and about 176° C., more specifically between about 173° C. and about 175° C., still more specifically between about 174° C. and about 175° C., and, in particular, about 174° C. A second form was also noted that had a melting point between about 171° C. and about 173° C., more particularly between about 171° C. and about 172° C., and in particular about 172° C. A powder diffraction pattern is shown in FIG. 2.

Thus, the present invention provides methods for making the therapeutic compound, 2-([Bis(3-chloro-4-methylphenyl)boryl]oxy}carbonyl)pyridin-3-ol (API), and various chemical forms of that compound.

While this invention has been disclosed with reference to specific embodiments, it is apparent that other embodiments and variations of this invention may be devised by others skilled in the art without departing from the true spirit and scope of the invention.

All patents, patent applications, and other publications cited in this application are incorporated by reference in the entirety.

What is claimed:

1. A method for manufacturing a compound of Formula I 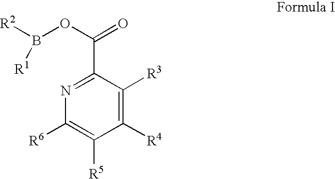
and its pharmaceutically acceptable salts, hydrates, and solvates, said method comprising:
(a) reacting nucleophilic equivalents of R¹ and R² with a trialkylborate to form an alkyl borinic acid ester;
(b) treating the borinic acid ester with an absorbent; and
(c) combining the treated borinic acid ester with a picolinic acid under conditions effective to form the compound
wherein
R¹ and R² are selected independently from the group consisting of alkyl, heteroalkyl, aryl and heteroaryl;
R³-R⁶ are members independently selected from the group consisting of hydrogen, hydroxy, amino, carboxy, cyano, halo, nitro, sulfo, thio, carbamoyl, substituted or unsubstituted alkyl, substituted or unsubstituted heteroalkyl, substituted or unsubstituted aryl and substituted or unsubstituted heteroaryl, and
R⁵ and R⁶ together with the ring to which they are attached form an optionally substituted aromatic ring.

2. The method of claim 1, wherein R¹ is substituted or unsubstituted aryl.

3. The method of claim 2, wherein R² is substituted or unsubstituted aryl.

4. The method of claim 1, wherein R¹ and R² both are substituted or unsubstituted phenyl.

5. The method of claim 1, wherein R¹ and R² both are phenyl substituted with alkyl and halo.

6. The method of claim 1, wherein R₁ and R₂ both are 3-chloro-4-methylphenyl.

7. The method of claim 6, wherein the nucleophilic equivalents of R₁ and R₂ is 3-chloro-4-methylphenyl magnesium bromide.

8. The method of claim 7, wherein the trialkylborate is trimethylborate.

9. The method of claim 8, wherein the borinic acid ester is methyl bis(3-chloro-4-methylphenyl)borinate.

10. The method of claim 1, wherein the picolinic acid is 3-hydroxypicolinic acid.

11. The method of claim 1, wherein the absorbent is activated carbon.

12. The method of claim 1, further comprising treating the picolinic acid with an absorbent.

13. The method of claim 12, wherein the absorbent is activated carbon.

14. The method of claim 8, further comprising combining the picolinic acid with the trimethylborate under conditions effective to form 2-({[bis(3-chloro-4-methylphenyl)boryl]oxy}carbonyl)pyridin-3-ol.

15. The method of claim 14, wherein the 2-({[bis(3-chloro-4-methylphenyl)boryl]oxy}carbonyl)pyridin-3-ol is in crystalline form.

16. The method of claim 15, wherein the crystals of2-({[bis(3-chloro-4-methylphenyl)boryl]oxy}carbonyl)pyridin-3-ol are substantially anhydrous.

17. The method of claim 16, wherein the crystals are prepared from an ethanol-water mixture.

18. The method of claim 15, wherein the crystals have a melting point between about 170° C. and about 176° C.

19. The method of claim 18, wherein the crystals have a melting point between about 173° C. and about 175° C.

20. The method of claim 19, wherein the crystals have a melting point between about 174° C. and about 175° C.

21. The method of claim 20, wherein the crystals have a melting point of about 174° C.

22. The method of claim 18, wherein the crystals have a melting point between about 171° C. and about 173° C.

23. The method of claim 22, wherein the crystals have a melting point of between about 171° C. and about 172° C.

24. The method claim 23, wherein the crystals have a melting point of about 172° C.

26. A method for producing 2-({[bis(3-chloro-4-methylphenyl)boryl]oxy}carbonyl)pyridin-3-ol, and its pharmaceutically acceptable salts, hydrates, and solvates, comprising:
reacting 3-chloro-4-methylphenyl magnesium bromide with trimethylborate under conditions effective to form methyl bis(3-chloro-4-methylphenyl)borinate;
treating the methyl bis(3-chloro-4-methylphenyl)borinate with an absorbent; and
reacting the methyl bis(3-chloro-4-methylphenyl)borinate with 3-hydroxypicolinic acid under conditions effective to form 2-({[bis(3-chloro-4-methylphenyl)boryl]oxy}carbonyl)pyridin-3-ol.

27. The method of claim 26, wherein said treating step further comprises adding ethanol to the methyl bis(3-chloro-4-methylphenyl)borinate followed by heating of the mixture of the ethanol and the methyl bis(3-chloro-4-methylphenyl)borinate.

28. The method of claim 26, wherein the absorbent is activated carbon.

29. The method of claim 28, further comprising filtering the carbon from the mixture.

30. The method of claim 26, further comprising treating the 3-hydroxypicolinic acid with an absorbent.

31. The method of claim 30, wherein the absorbent is activated carbon.

32. The method of claim 31, further comprising filtering the mixture of the ethanol and the methyl bis(3-chloro-4-methylphenyl)borinate prior to combining with the 3-hydroxypicolinic acid.

33. The method of claim 32, wherein the 2-({[bis(3-chloro-4-methylphenyl)boryl]oxy}carbonyl)pyridin-3-ol is in crystalline form.

34. The method of claim 33, wherein the 2-({[bis(3-chloro-4-methylphenyl)boryl]oxy}carbonyl)pyridin-3-ol crystals are formed by seeding with an authentic source of pure 2-({[bis(3-chloro-4-methylphenyl)boryl]oxy}carbonyl)pyridin-3-ol.

35. The method of claim 34, wherein the crystals are formed from an ethanol-water solution.

36. The method of claim 35, wherein the crystals of the 2-({[bis(3-chloro-4-methylphenyl)boryl]oxy}carbonyl)pyridin-3-ol are substantially anhydrous.

37. The method of claim 36, wherein the crystals have a melting point between about 170° C. and about 176° C.

38. The method of claim 37, wherein the crystals have a melting point between about 173° C. and about 175° C.

39. The method of claim 38, wherein the crystals have a melting point between about 174° C. and about 175° C.

40. The method of claim 39, wherein the crystals have a melting point of about 174° C.

41. The method of claim 37, wherein the crystals have a melting point between about 171° C. and about 173° C.

42. The method of claim 41, wherein the crystals have a melting point of between about 171° C. and about 172° C.

43. The method of claim 42, wherein the crystals have a melting point of about 172° C.

44. A method for producing 2-({[bis(3-chloro-4-methylphenyl)boryl]oxy}carbonyl)pyridin-3-ol, and its pharmaceutically acceptable salts, hydrates, and solvates, comprising:
reacting 3-chloro-4-methylphenyl magnesium bromide with trimethylborate under conditions effective to form methyl bis(3-chloro-4-methylphenyl)borinate;
treating the methyl bis(3-chloro-4-methylphenyl)borinate with ethanol and a first absorbent to form a mixture which is heated;
treating 3-hydroxypicolinic acid with a second absorbent;
filtering the mixture of the second absorbent and the 3-hydroxypicolinic acid and the mixture of the first absorbent and the methyl bis(3-chloro-4-methylphenyl)borinate; and
reacting the filtered bis(3-chloro-4-methylphenyl)borinate with the filtered 3-hydroxypicolinic acid under conditions effective to form 2-({[bis(3-chloro-4-methylphenyl)boryl]oxy}carbonyl)pyridin-3-ol.

45. The method of claim 44, wherein the first and second absorbents are activated carbon.

46. The method of claim 44, wherein the 2-({[bis(3-chloro-4-methylphenyl)boryl]oxy}carbonyl)pyridin-3-ol is in crystalline form.

47. The method of claim 46, wherein the crystals are substantially anhydrous.

48. The method of claim 47, wherein the crystals are formed from an ethanol-water solution.

49. The method of claim 48, wherein the crystals have a melting point between about 170° C. and about 176° C.

50. The method of claim 49, wherein the crystals have a melting point between about 173° C. and about 175° C.

51. The method of claim 50, wherein the crystals have a melting point between about 174° C. and about 175° C.

52. The method of claim 51, wherein the crystals have a melting point of about 174° C.

53. The method of claim 49, wherein the crystals have a melting point between about 171° C. and about 173° C.

54. The method of claim 53, wherein the crystals have a melting point of between about 171° C. and about 172° C.

55. The method claim 54, wherein the crystals have a melting point of about 172° C.

56. The compound 2-({[bis(3-chloro-4-methylphenyl)boryl]oxy)carbonyl)pyridin-3-ol in substantially anhydrous crystalline form.

57. The compound of claim 56, wherein the crystals have a melting point between about 170° C. and about 176° C.

58. The compound of claim 57, wherein the crystals have a melting point between about 173° C. and about 175° C.

59. The compound of claim 58, wherein the crystals have a melting point between about 174° C. and about 175° C.

60. The compound of claim 59, wherein the crystals have a melting point of about 174° C.

61. The compound of claim 57, wherein the crystals have a melting point between about 171° C. and about 173° C.

62. The compound of claim 61, wherein the crystals have a melting point of between about 171° C. and about 172° C.

63. The compound claim 62, wherein the crystals have a melting point of about 172° C.

64. A pharmaceutical composition comprising a pharmaceutically effective amount of a compound of claim 56.

65. The pharmaceutical composition of claim 64, wherein the composition is stored in a sealed container.

66. The pharmaceutical composition of claim 65, wherein the container is light-resistant.

67. The pharmaceutical composition of claim 66, wherein the container is a member selected from an ampule, a bag and a bottle.
